(19) United States
(12) Patent Application Publication
(10) Pub. No.: US 2009/0207494 A1
(43) Pub. Date: Aug. 20, 2009

(54) Laparoscopic camera

(76) Inventors: Daniel Gelbart, Vancouver (CA); Samuel Victor Lichtenstein, Vancouver (CA)

Correspondence Address: Daniel Gelbart, 4706 Drummond Dr, Vancouver, BC, V6T-1B4, CA

(21) Appl. No.: 12/071,315

(22) Filed: Feb. 20, 2008

(51) Int. Cl. B08B 5/00

(52) U.S. Cl. 359/509

(57) ABSTRACT

The lens at the tip of a laparoscopic camera is kept clean by creating a compartment in front of it pressurized by CO₂ gas. The gas exits the compartment via a small aperture that also serves as an aperture for the optical system. The escaping gas is vented to the body cavity. Because of the small size of the aperture, even a small gas flow prevents fluids from entering the cavity and soiling the lens.

### FIELD OF THE INVENTION

The invention is in the medical field and in particular in the field of cameras for laparoscopic or minimally invasive surgery.

### BACKGROUND OF THE INVENTION

In laparoscopic surgery there is a need to insert vision devices such as endoscopes or electronic cameras also known as “laparoscopic cameras” into the human body in order to guide the surgeon. In some application there is no surgery involved, just observation, as is the case when direct vision or electronic endoscopes are used for observing the digestive tract, urinary tract or airways. Most of these devices also contain an illumination system in which the light is fed through the same tube as the returned image. This is typically done by the use of a fiber optics bundle but can also be done by using lenses and beam-splitters. The camera is typically outside the body and the image is transferred via a coherent fiber optics bundle or via relay lenses. This part of the system is commonly referred to as the “telescope”. In all these cases the exposed lens or optical window at the tip of the device is easily soiled by bodily fluids such as blood or other contaminants. This required frequent removal and cleaning. Prior art concentrated on easy ways of cleaning the optical window or lens but there was no simple method of keeping the tip from soiling. It is an object of the invention to provide a simple method of keeping the optical end of the device clean. Other objects and advantages will become apparent by studying the disclosure and the drawings. In this disclosure the term “optical window” is used to describe the outermost element of the optical system, regardless whether it is a lens, plain window, or any other optical element. The term “illuminator” refers to any system for delivering illumination such as a fiber optics bundle, mirrors, lenses or light emitting sources such as LEDs built into the telescope.

### SUMMARY OF THE INVENTION

The lens at the tip of a laparoscopic camera is kept clean by creating a compartment in front of it pressurized by CO₂ gas. The gas exits the compartment via a small aperture that also serves as an aperture for the optical system. The escaping gas is vented to the body cavity. Because of the small size of the aperture, even a small gas flow prevents fluids from entering the cavity and soiling the lens.

### BRIEF DESCRIPTION OF THE DRAWINGS

FIG. 1 is a cross section of a laparoscopic operation.

FIG. 2 is a traverse cross section of the telescope inserted into the body.

FIG. 3 is a cross section of a telescope according to the invention.

FIG. 4 is a cross section of a telescope according to the invention using telecentric optics.

### DETAILED DISCLOSURE

In FIG. 1 a laparoscopic camera 1, typically of the CCD type, is used to view the inside of cavity 4 in tissue 3. The cavity is sometimes held open by inflating it with CO₂ gas. The image is relayed to the camera via a telescope 6 which also includes an illuminator 2, typically of the fiber-optics type. A separate port 5 is used for the surgical instruments. At the end of telescope 6 there is an optical window 11 that has to be kept clean. This is done by forming a second cavity 12 in front of window 11 by using shield 7. Shield 7 has a small aperture 8. CO₂ gas is pumped via tube 9 and exits via aperture 8. The escaping gas 15 prevents liquids and other matter from entering cavity 12 and keeps window 11 clean and free of fogging. Window 11 can be a lens, a protective window or any other optical element. The gas escapes cavity 4 via exhaust tube 10 or any other ports. If desired, the gas can be recirculated in order to avoid venting gas into the operating room. Other gasses and fluids, such as saline solution or medicated solutions, can be used as well.

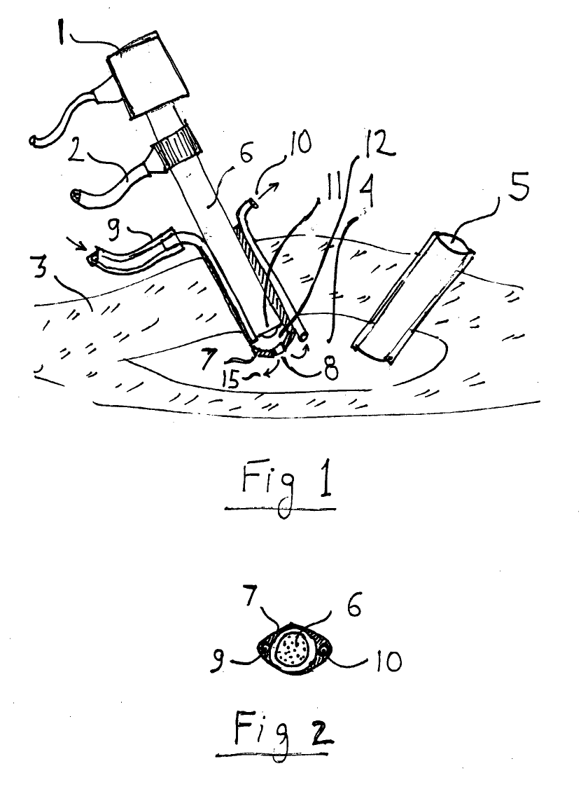

Tubes 9, 10 and sheath 7 can form a single assembly as shown in the traverse cross section of FIG. 2. Exhaust tube 10 can also be located elsewhere, as long as it communicates with cavity 4.

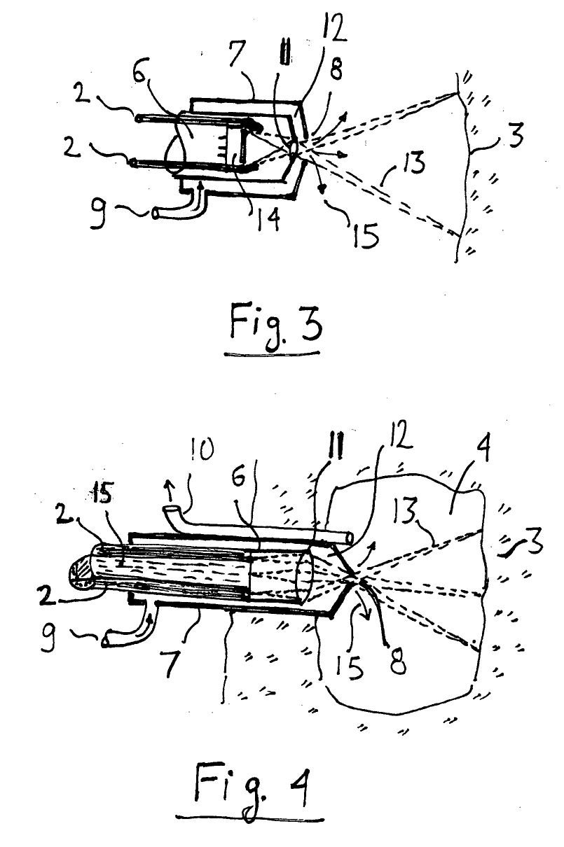

In order to have a clear view through the small aperture 8 several optical methods can be used. FIG. 3 shows the use of a small lens and placing aperture 8 very close to the lens. Aperture 8 approximately defines the optical aperture of the lens and the f/# of rays 13. This method is particularly suited for a telescope 6 based on relay lenses or containing the image sensor 14 inside the telescope. Illumination can be provided by fiber optics bundles 2. Tips of bundles 2 have to be directed at aperture 8, as shown in FIG. 3. The smaller aperture 8 can be made the less gas flow is required to keep it clean, however there are two optical limits: illumination and resolving power. The aperture size divided by the distance between the aperture and the tissue 3 defines the f/# of the optical system. The smaller the aperture the better the depth of focus but the lower is the theoretical (diffraction limited) resolution. A preferred ratio is the aperture being from 0.2 to 0.02 of the distance. This corresponds to f/# from f/5 to f/50. For most applications this translated to aperture sizes of 0.5-5 mm. The illumination has to be designed to fit through this aperture. Modern CCD cameras are very sensitive, thus illumination is not a major constraint on the design.

A more flexible system is show in FIG. 4. Lens 11 is telecentric. In a telecentric lens all rays pass through one of the focal points of the lens and are parallel at the other side of the lens. This is important when coupling the image to a coherent fiber optics bundle 15, because the direction and cone angle of rays 13 can be well matched to the optical fibers, and a small aperture 8 can be used even with a large lens 11. The illumination fibers 2 can be placed around coherent bundle 15. The illumination light will also fit through aperture 8 because of the telecentric imaging. This design also keeps the optical window or lens 11 further away from the aperture 8, making it harder for contaminants to reach it. In order to achieve telecentric imaging the distance between aperture 8 and lens 11 equals the focal length of the lens.

While the preferred embodiment is for a laparoscopic camera, it is clear that the invention can be used for any type of visual instruments, such as endoscopes inserted into the body, both for direct vision by the eye and for electronic cameras. The invention is equally useful for 2D and 3D cameras.

1. A system for keeping an optical window of a laparoscopic camera clean by forming a compartment pressurized by a fluid in front of said window, said fluid leaving said compartment via an aperture located in front of said window.

2. A system for keeping an optical window of an endoscope clean by forming a compartment pressurized by a fluid in front of said window, said fluid leaving said compartment via an aperture located in front of said window.

3. A system for keeping the end of a laparoscopic telescope clean by forming a compartment pressurized by a fluid at the end of said telescope, said fluid leaving said compartment via an aperture located in front of telescope and allowing the image to be seen through said aperture.

4. A system as in claim 1 wherein said fluid is CO₂ gas.

5. A system as in claim 2 wherein said fluid is CO₂ gas.

6. A system as in claim 3 wherein said fluid is CO₂ gas.

7. A system as in claim 1 wherein said window is part of a telecentric optical system.

8. A system as in claim 2 wherein said window is part of a telecentric optical system

9. A system as in claim 3 wherein said window is part of a telecentric optical system

10. A system as in claim 1 wherein said aperture forms part of an optical system having an f/# of between f/5 to f/50.

11. A system as in claim 2 wherein said aperture forms part of an optical system having an f/# of between f/5 to f/50.

12. A system as in claim 3 wherein said aperture forms part of an optical system having an f/# of between f/5 to f/50.

13. A system as in claim 1 wherein said fluid is recirculated.

14. A system as in claim 2 wherein said fluid is recirculated.

15. A system as in claim 3 wherein said fluid is recirculated.

16. A system as in claim 1 wherein size of said aperture is between 0.5 to 5 mm.

17. A system as in claim 2 wherein size of said aperture is between 0.5 to 5 mm.

18. A system as in claim 3 wherein size of said aperture is between 0.5 to 5 mm.
